(19) United States
(12) Patent Application Publication
(10) Pub. No.: US 2012/0313840 A1
(43) Pub. Date: Dec. 13, 2012

(54) IMAGE DISPLAY DEVICE AND AUTOSTEREOSCOPIC PANEL

(75) Inventor: Masanao TSUTSUI, Nagano (JP)

(73) Assignee: Sony Corporation, Minato-ku (JP)

(21) Appl. No.: 13/466,585

(22) Filed: May 8, 2012

(30) Foreign Application Priority Data
Jun. 7, 2011 (JP) 2011-127752

(51) Int. Cl. G09G 5/00

(52) U.S. Cl. 345/6

(57) ABSTRACT

An information processing apparatus that determines whether an autostereoscopic panel is attached to a display, and controls the display to display a two-dimensional (2D) image or three-dimensional (3D) image based on the determination.

### CROSS REFERENCE TO RELATED APPLICATION

This application claims the benefit of priority under 35 U.S.C. §119 to Japanese Priority Patent Application JP 2011-127752 filed in the Japan Patent Office on Jun. 7, 2011, the entire contents of which are hereby incorporated by reference.

### BACKGROUND

The present disclosure relates to an image display device that selectively displays a 2D picture or a 3D picture and an autostereoscopic panel mounted in the image display device.

Recently, a technology of mounting a lenticular lens, which is an autostereoscopic panel, on a display that displays pictures, and allows recognition of a 3D picture with the naked eyes has been proposed (for example, see Japanese Unexamined Patent Application Publication (Translation of PCT Application) No. 2005-507091 and Japanese Unexamined Patent Application Publication No. 2010-231009).

A technology of mounting a stereoscopic device that is an autostereoscopic panel on a display is described in PCT Japanese Translation Patent Publication No. 2005-507091. A mounting mechanism is used to mount the stereoscopic device on the display. The mounting mechanism includes a separable spring handle and a spring clip mount fixing the display and the stereoscopic device. In the mounting mechanism, the rear of the display and the surface opposite to the surface being in contact with the display, in the stereoscopic device are disposed with the spring clip mount.

Further, an electronic optical device including a liquid crystal panel that is a display unit and a lenticular lens sheet that is an autostereoscopic panel is disclosed in Japanese Unexamined Patent Application Publication No. 2010-231009. The lenticular lens is disposed on the front of the liquid crystal panel. Further, an alignment line for aligning the liquid crystal panel with the lenticular lens sheet is formed on the lenticular lens sheet.

### SUMMARY

However, according to the stereoscopic device described in PCT Japanese Translation Patent Publication No. 2005-507091, it is necessary for a user to adjust the mounting position every time while viewing the test image displayed on the display. Further, it is necessary for the user to manually change a 2D picture or a 3D picture displayed on the display each time the autostereoscopic panel is attached/detached.

Further, even in the electronic optical device described in Japanese Unexamined Patent Application Publication No. 2010-231009, it is necessary for the user to manually change a 2D picture or a 3D picture displayed on the display each time the autostereoscopic panel is attached/detached.

It is desirable to provide an image display device making it unnecessary to manually change a 2D picture or a 3D picture and an autostereoscopic panel that is mounted in the image display device.

According to an embodiment of the present disclosure, an image display device includes a display unit, a determining unit, and a display control unit. The display unit selectively displays a 2D picture or a 3D picture. The determining unit determines attachment/detachment of an autostereoscopic panel detachably mounted on the display unit. The display control unit selectively displays a 2D picture or a 3D picture on the display unit on the basis of the determination of the determining unit.

The “autostereoscopic panel” described herein is a panel that allows a user to see a 3D picture displayed on the display unit with the naked eyes.

Further, according to another embodiment of the present disclosure, an autostereoscopic panel includes a panel main body and a recognizer. The panel main body is detachably mounted on an image display device that can selectively display a 2D picture or a 3D picture. Further, the recognizer is disposed on the panel main body and recognizes attachment/detachment of the panel main body by the determining unit of the image display device.

According to an image display device of the present disclosure, since the determining unit determines attachment/detachment of an autostereoscopic panel, it is possible to automatically select and display a 2D picture or a 3D picture on the display unit without manually changing the pictures.

Further, according to the image display device of the present disclosure, the recognizer is provided, it is possible to easily determine whether the autostereoscopic panel is mounted on the display unit of the image display device.

### BRIEF DESCRIPTION OF THE DRAWINGS

FIGS. 1A and 1B are perspective views showing an image display device according to an embodiment of the present disclosure, in which FIG. 1A shows when an autostereoscopic panel is not mounted yet on a display unit of the image display device and FIG. 1B shows when the autostereoscopic panel is mounted on the display unit of the image display device.

FIG. 2 is a block diagram showing the configuration of the image display device according to an embodiment of the present disclosure.

FIG. 3 is a cross-sectional view seen from above when the autostereoscopic panel has been mounted on the image display device according to an embodiment of the present disclosure.

FIG. 4 is a cross-sectional view of the main parts seen from above when the autostereoscopic panel has been mounted on the image display device according to an embodiment of the present disclosure.

FIG. 5 is a view showing an example of an image captured by an imaging unit before an autostereoscopic panel is mounted on the image display device according to an embodiment of the present disclosure.

FIG. 6 is a view showing an example of an image captured by an imaging unit when an autostereoscopic panel has been mounted on the image display device according to an embodiment of the present disclosure.

FIG. 7 is a flowchart showing a process of changing a picture when a 2D picture is displayed on the display unit of the image display device according to an embodiment of the present disclosure.

FIG. 8 is a flowchart showing a process of changing a picture when a 3D picture is displayed on the display unit of the image display device according to an embodiment of the present disclosure.

FIG. 9 is a view showing a recognizer in an autostereoscopic panel according to another embodiment of the present disclosure.

FIG. 10 is a view showing an image captured by an imaging unit when an autostereoscopic panel according to another embodiment of the present disclosure is first mounted.

FIGS. 11A and 11B are views showing an example of an image captured by an imaging unit when an autostereoscopic panel according to another embodiment of the present disclosure has been mounted the second and subsequent times.

FIG. 12 is a flowchart showing a process of adjusting a display position of a picture displayed on the display unit of the image display device according to an embodiment of the present disclosure.

FIG. 13 is a view showing a recognizer in an autostereoscopic panel according to another embodiment of the present disclosure.

FIG. 14 is a flowchart showing a process of determining whether an autostereoscopic panel mounted on the display unit of the image display device according to an embodiment of the disclosure is suitable for the display unit.

### DETAILED DESCRIPTION OF EMBODIMENTS

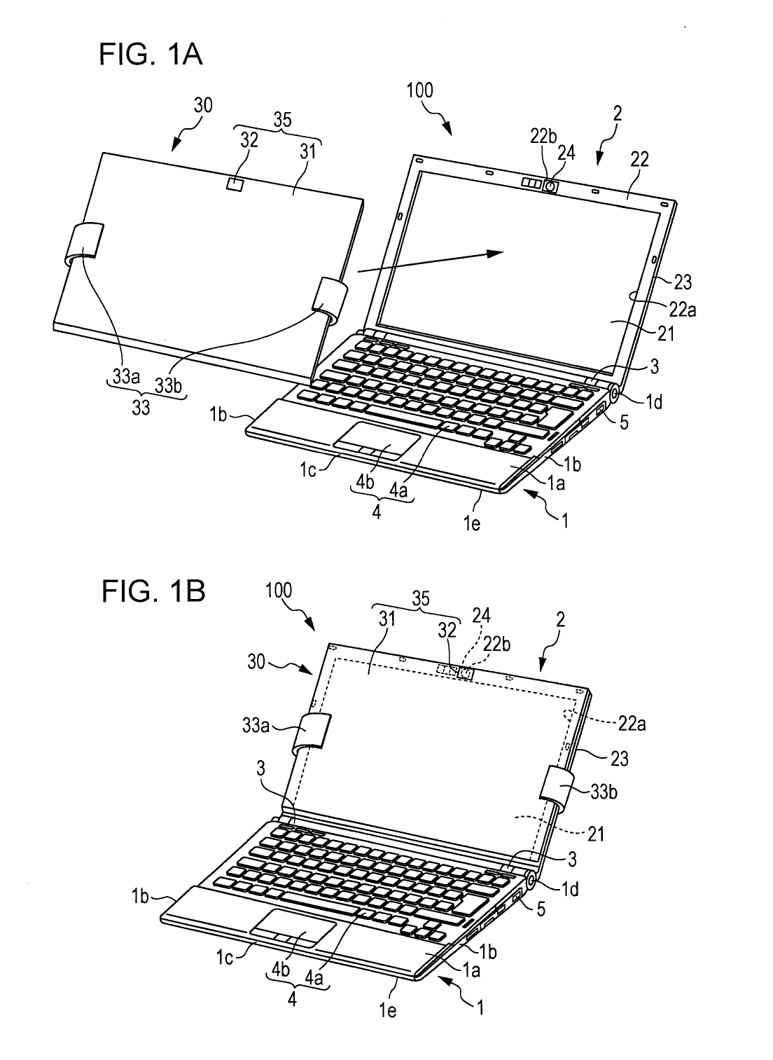

Hereinafter, embodiments of an image display device and an auto stereoscopic panel of the present disclosure are described with reference to FIGS. 1 to 14. Further, the common components are given the like reference numerals in the drawings. Further, the present disclosure is not limited to the following embodiments.

Further, the description is provided in the following order.

1. Example of Configuration of Image Display Device

2. Example of Configuration of Autostereoscopic Panel

3. Method of Mounting Autostereoscopic Panel

4. Example of Operation of Image Display Device

5. Example of Another Configuration of Recognizer in Autostereoscopic Panel

### <1. Example of Configuration of Image Display Device>

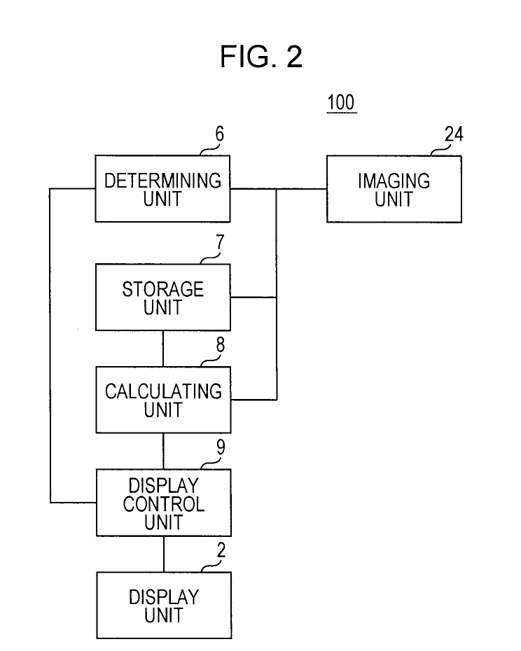

An embodiment (hereafter, “the example”) of an image display device of the present disclosure is described first with reference to FIGS. 1A and 2.

FIG. 1A is a perspective view showing when an autostereoscopic panel is not yet mounted on a display unit of the image display device and FIG. 1B is a perspective view showing when the autostereoscopic panel has been mounted on the display unit of the image display device. Further, FIG. 2 is a block diagram showing the configuration of the image display device according to the example.

As shown in FIG. 1A, an image display device 100 of the example includes a main body 1, a display unit 2, and a hinge mechanism 3 rotatably connecting the main body 1 with the display unit 2.

### [Main Body]

The main body 1 is formed in a substantially flat rectangular shape. The main body 1 has a substantially rectangular main surface 1a, two sides 1b, a front 1c, a rear 1d, and a placing surface 1e. The two sides 1b are disposed at both longitudinal ends of the main surface 1a. The two sides 1b are formed substantially perpendicular to the main surface 1a.

The front 1c is continuously formed at one transverse end of the main surface 1a. Further, the rear 1d is disposed at the other transverse end of the main surface 1a. The rear 1d is disposed opposite to the front 1c. Further, the placing surface 1e is formed opposite to the main surface 1a.

An input unit 4 is disposed on the main surface 1a. The input unit 4 includes a key-typed input portion 4a with a plurality of keys and a touch-typed input portion 4b, which is a kind of pointing device. A control signal is input from the input unit 4 and predetermined information processing or the like is performed. The input type of the touch-typed input portion 4b, for example, may be a capacitance type or a resistive film type.

A connection terminal 5 for connection with an external device, such as an external hard disk drive or a USB flash memory is disposed at the sides 1b.

Further, the hinge mechanism 3 is disposed at both left and right ends of the rear 1d. The hinge mechanism 3 rotatably couples the display unit 2 to the main body 1. The hinge mechanism 3 can hold the display unit 2 at a predetermined angle with respect to the main body 1.

### [Display Unit]

Next, the display unit 2 is described.

As shown in FIG. 1A, the display unit 2 is formed in a substantially flat rectangular shape. The display unit 2 includes a display panel 21, a front plate 22, and a rear plate 23. Further, a built-in imaging unit 24 is disposed in the display unit 2.

The display panel 21, for example, may be a liquid crystal display, an organic electroluminescence display, or a surface-conduction electron-emitter display. Though not shown, a backlight radiating light to the rear of the display panel 21 or a circuit board or the like where a control device controlling an image on the display panel 21 is received between the display panel 21 and the rear plate 23. Therefore, it is possible to display a variety of information, a 2D picture, or a 3D picture on the display panel 21.

The front plate 22 is a substantially rectangular flat plate. A first opening 22a and a second opening 22b are formed at the front plate 22. The display panel 21 is fixed by a frame member (not shown) to the front plate 22. The display panel 21 fixed to the front plate 22 is exposed through the first opening 22a. Accordingly, the size of the first opening 22a depends on the size of the display panel 21.

The second opening 22b is disposed at the center in one long side of the front plate 22. The imaging unit 24 fixed to the rear plate 23 is exposed through the second opening 22b. Accordingly, the size of the second opening 22b depends on the size of the imaging unit 24.

The rear plate 23 is, similar to the front plate 22, a substantially rectangular flat plate. The rear plate 23 is disposed opposite to the display surface of the display panel 21 and covers all of the area of the display panel 21 and the front plate 22.

The imaging unit 24 is fixed to the rear plate 23, inside the display unit 2. The imaging unit 24 is positioned to be overlapped by the second opening 22b and exposed through the second opening 22b. The imaging unit 24 captures an image used for facial recognition or an image that is used for the determination of a determining unit 6. Further, the image captured by the imaging unit 24 is used to locate a user.

As shown in FIG. 2, the image display device 100 includes the determining unit 6, a memory unit 7, a calculating unit 8, and a display control unit 9. Image data captured by the imaging unit (see FIG. 1A) is input to the determining unit 6, the memory unit 7, and the calculating unit 8. The determining unit 6 determines whether an autostereoscopic panel 30 is attached or detached on the basis of the image data. The determination data determined by the determining unit 6 is input to the display control unit 9. Further, the memory unit 7 acquires and stores the position information of the autostereoscopic panel 30 with respect to the display unit 2 from the image captured by the imaging unit, when the autostereoscopic panel 30 is initially mounted on the display unit 2.

When the autostereoscopic panel 30 mounted on the display unit 2 the second and subsequent time, the calculating unit 8 calculates a correction value by comparing the position information of the autostereoscopic panel 30 with respect to the display unit 2, which is acquired from the image captured by the imaging unit 24 with the position information of the autostereoscopic panel 30 which is stored in the memory unit 7. Further, the correction value calculated by the calculating unit 8 is input to the display control unit 9. The display control unit 9 selectively displays a 2D picture or a 3D picture on the display unit 2 on the basis of the determination of the determining unit 6. Further, the display control unit 9 displays a 3D picture with the display position adjusted, on the basis of the correction value calculated by the calculating unit 8, on the display unit 2. Further, the display control unit 9 locates the user, using the image captured by the imaging unit 24 and performs fine adjustment on the 3D picture displayed on the display unit 2. Further, the detailed operation of the image display device 100 is described below.

Further, although an example of using a notebook type personal computer is described as an image display device herein, the present disclosure is not limited thereto. For example, a desktop type personal computer, a television receiver, or a portable terminal may be used as the other examples of the image display device.

### <2. Example of Configuration of Autostereoscopic Panel>

Next, an embodiment of the autostereoscopic panel 30 is described with reference to FIGS. 1A and 1B.

As shown in FIG. 1A, the autostereoscopic panel 30 is composed of a panel main body 35 that is a substantially rectangular flat plate and two fixers 33. The panel main body 35 has a transmissive portion 31 and a recognizer 32.

The transmissive portion 31 is implemented, for example, by a lenticular lens. When the picture displayed on the display unit 2 is projected through the transmissive portion 31, the user can see a 3D picture with naked eyes.

The recognizer 32 is formed at the longitudinal center portion of the panel main body 35, that is, at one transverse end of the panel main body 35. As shown in FIG. 1B, the recognizer 32 is positioned to overlap the imaging unit 24 of the display unit 2, with the autostereoscopic panel 30 mounted on the display unit 2. Further, the size of the recognizer 32 is set to fit to the imaging range of the imaging unit 24.

The entire recognizer 32 is applied with a recognition color. The color applied to the entire recognizer 32 is a color that does not influence the image captured by the imaging unit 24 in facial recognition of the image display device 100. The color that does not influence the facial recognition of the image display device 100 may be, for example, a color that does not too much influence the luminance of the image captured by the imaging unit 24.

Further, the recognizer 32 may be formed by bonding a colored seal. Although the recognizer 32 is formed by the color that does not influence the image that is used for facial recognition in the present disclosure, the recognizer 32 may be formed in a shape that does not influence the image that is used for facial recognition. Further, the recognizer 32 may be implemented by a color or a shape that influences the image that is used for facial recognition.

Further, when the recognizer 32 may be implemented by a color or a shape that influences the image that is used for facial recognition, it is preferable to dispose the recognizer 32 at a position where facial recognition is not influenced. The position that does not influence facial recognition may be, for example, the corners of the image captured by the imaging unit 24.

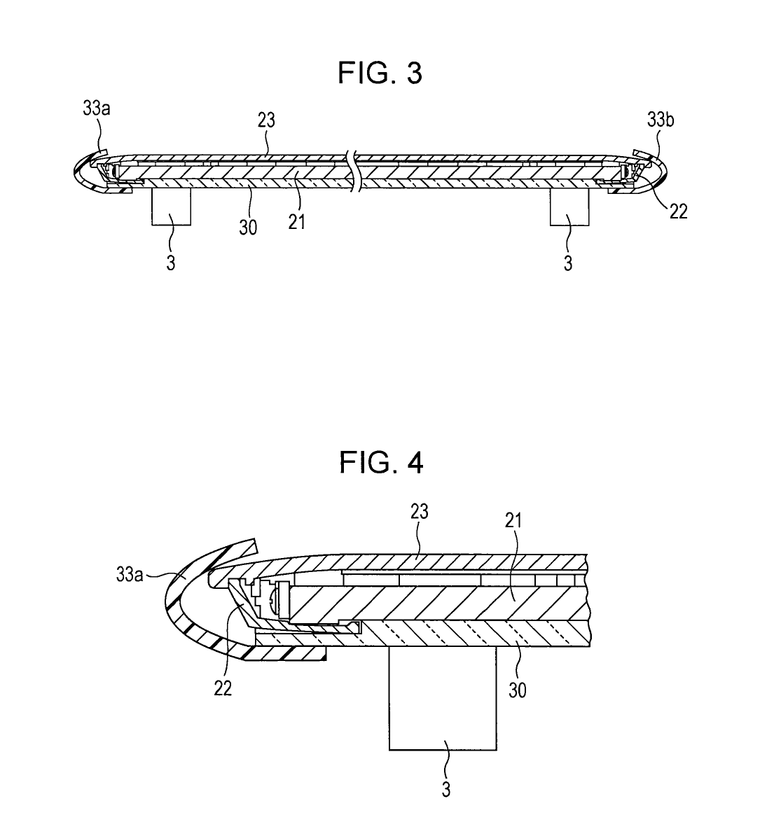

The two fixers 33 are fixed both the longitudinal ends of the panel main body 35, respectively. As a fixing method of fixers 33, the fixers 33 may be fixed by forming openings at both longitudinal ends of the panel main body 35 and fitting the fixers 33 into the openings, other than using laser welding or an adhesive. The fixers 33 are formed in a substantially V-shape, and a shown in FIG. 1B, are interposed between the front plate 22 and the rear plate 23, with the autostereoscopic panel 30 mounted on the display unit 2 (see FIG. 3).

The two fixers 33 are made of an elastic material and composed of a first fixer 33a and a second fixer 33b. The first fixer 33a is disposed at one longitudinal end of the panel main body 35 and the second fixer 33b is disposed at the other longitudinal end of the panel main body 35. The modulus of elasticity of the first fixer 33a is different from the modulus of elasticity of the second fixer 33b and the modulus of elasticity of the first fixer 33a is larger than the modulus of elasticity of the second fixer 33b.

Further, since the accuracy of positioning is low when only one fixer 33 is provided, it is preferable to dispose two or more fixer 33 at the panel main body 35. Although two fixers 33 are provided in the present disclosure, three of more fixers 33 may be provided. Accordingly, it is possible to improve the accuracy of positioning the autostereoscopic panel 30.

### <3. Method of Mounting Autostereoscopic Panel>

Next, a method of mounting the autostereoscopic panel 30 is described with reference to FIG. 1B, and FIGS. 3 and 4.

FIG. 3 is a cross-sectional view of the image display device of FIG. 1B, seen from above. Further, FIG. 4 is a cross-sectional view showing the main parts of the image display device shown in FIG. 3.

First, a user holds the fixer of the autostereoscopic panel 30. Next, as shown in FIGS. 3 and 4, the user fastens the first fixer 33a with a larger modulus of elasticity in the fixer 33 to the rear plate 23 of the display unit 2. Thereafter, the user fastens the second fixer 33b with a smaller modulus of elasticity than the first fixer 33a to the rear plate 23 of the display unit 2. In this state, the transmissive portion 31 of the autostereoscopic panel 30 is in contact with the display panel 21 and the front plate 22 of the display unit 2. As a result, the transmissive portion 31 of the autostereoscopic panel 30 and the display panel 21 are in close contact by the holding force of the two fixers 33.

Next, the autostereoscopic panel 30 is vertically positioned. The autostereoscopic panel 30 is moved to the main body 1 in the longitudinal direction of the display unit 2, such that the lower surface of the panel main body 35 is brought in contact with the lower surface of the first opening 22a. Accordingly, as shown in FIG. 1B, the recognizer 32 of autostereoscopic panel 30 overlaps the position of the imaging unit 24. As a result, mounting autostereoscopic panel 30 is finished. Further, it may be possible to bring the lower surface of the panel main body 35 in contact with the main surface 1a or the hinge mechanism 3.

It may be considered to positioning the autostereoscopic panel with respect to the display unit by forming a notch on the panel main body of the autostereoscopic panel. It is necessary to consider in advance the notch of the panel main by when designing the display unit of the image display device in order to form the notch on the panel main body. Accordingly, the cost of the display unit of the image display device increases.

It is difficult to mount an autostereoscopic panel on the display panel of an image display device or the like without a notch on the panel main body, for example, a common display device.

Further, a gag is generated between the notch of the panel main body and the display unit, when a notch is formed at the panel main body. The mounting position of the autostereoscopic panel is unstable by the gap and an error of mounting position of the autostereoscopic panel is large. Therefore, the accuracy of positioning decreases and it is difficult to perform calibration described below. Accordingly, it is difficult to adjust the display position of the picture displayed on the display unit 2. For this reason, it is preferable to form a notch at the panel main body of the autostereoscopic panel.

On the other hand, the two fixers 33a and 33b of the autostereoscopic panel 30 according to an embodiment of the disclosure have a difference in modulus of elasticity. The first fixer 33a is larger in modulus of elasticity than the second fixer 33b. When the autostereoscopic panel 30 is mounted, the autostereoscopic panel 30 is biased to the first fixer 33a having a large modulus of elasticity in the longitudinal direction of the panel main body 35. Further, in the autostereoscopic panel 30, the transverse the other end of the panel main body 35 is in contact with the main surface 1a of the main body 1 and the hinge mechanism 3. Accordingly, the longitudinal side at the first fixer 33a of the panel main body 35 and the transverse end of the panel main body 35 are the reference of the positioning. As the reference is disposed, it is possible to mount the autostereoscopic panel 30 at substantially the same position with respect to the display unit 2 and reduce an error in mounting position. As a result, the accuracy of positioning the autostereoscopic panel 30 is improved. Therefore, it is not necessary to consider a notch of the panel main body when designing the image display device, such that it is possible to reduce the cost of designing the display unit of the image display device. Further, it is possible to mount the autostereoscopic panel 30 in a common image display device, such that it is possible to increase versatility.

### <4. Example of Operation of Image Display Device>

Next, an example of the operation of the image display device 100 is described.

The image display device 100 determines attachment/detachment of the autostereoscopic panel 30, automatically selects and changes a 2D picture or 3D picture, and automatically adjusts the display position of the 3D picture by the mounting position of the autostereoscopic panel.

### [Example of Attaching/Detaching Autostereoscopic Panel]

An example of determining attachment/detachment of the autostereoscopic panel 30 is described with reference to FIGS. 1A and 1B, and FIGS. 5 and 6.

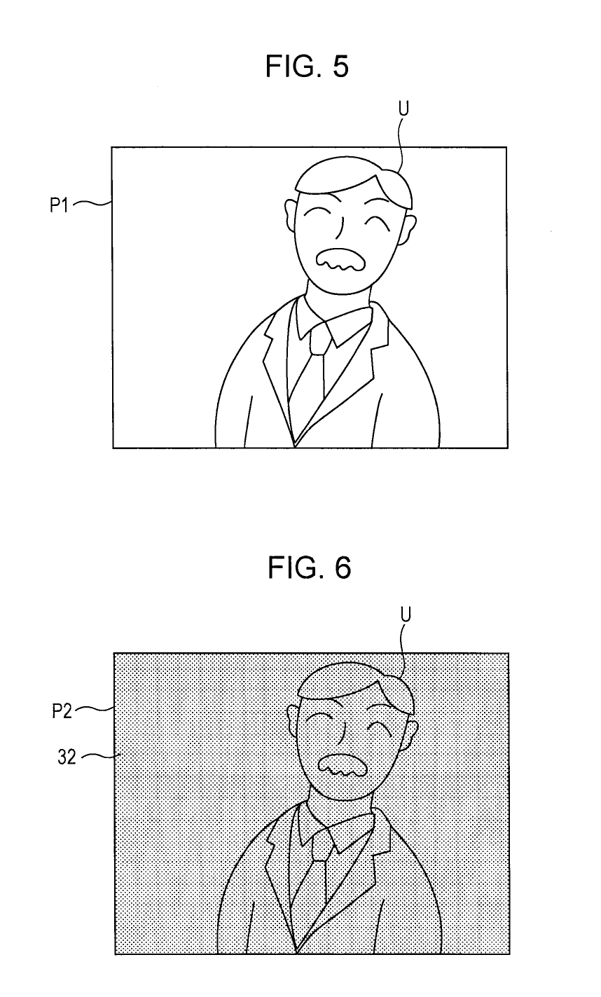

FIG. 5 is a view showing an image captured by the imaging unit 24 before the autostereoscopic panel 30 is mounted in the image display device 100 of the example. FIG. 6 is a view showing an image when the imaging unit 24 images the autostereoscopic panel 30 mounted in the image display device 100 of the example.

First, the imaging unit 24 captures the image P1 shown in FIG. 5 before the autostereoscopic panel 30 is mounted (see FIG. 1A). Only the user U is shown in the image P1 without a change in color. As a result, the determining unit 6 determines that there is no change in color and determines that the autostereoscopic panel 30 is not mounted on the display unit 2.

Next, as shown in FIG. 1B, the user mounts the autostereoscopic panel 30 on the display unit 2. The imaging unit 24 captures the image P2 shown in FIG. 6 after the autostereoscopic panel 30 is mounted on the display unit 2. In this process, since the imaging unit 24 overlaps the recognizer 32 of the autostereoscopic panel 30, the recognizer 32 of the autostereoscopic panel 30 is shown, in addition to the user U, such that the color changes. The determining unit 6 determines that there is a change in color of the image P2 and determines that the autostereoscopic panel 30 has been mounted on the display unit 2.

As described above, attachment/detachment of the autostereoscopic panel is determined by the imaging unit mounted on the image display device 100, for facial recognition or as web camera. Therefore, it is not necessary to newly dispose a switch or a camera for determining attachment/detachment, such that it is possible to reduce the cost for designing the image display device. Further, in the image display device, since the determination of attachment/detachment is controlled by a web camera and software, it is possible to easily apply the autostereoscopic panel 30 to various types image display device only by updating the software relating to the determination of attachment/detachment.

As an example of the operation of the image display device 100, attachment/detachment of the autostereoscopic panel 30 is determined by a change in color, but the present disclosure is not limited thereto. There may be a change in the acquired image, and for example, it is possible to change the acquired image by providing a plurality of dots or lines in the recognizer.

### [Change of Displayed Image]

Next, changing an image displayed on the display unit is described with reference to FIGS. 5 to 8.

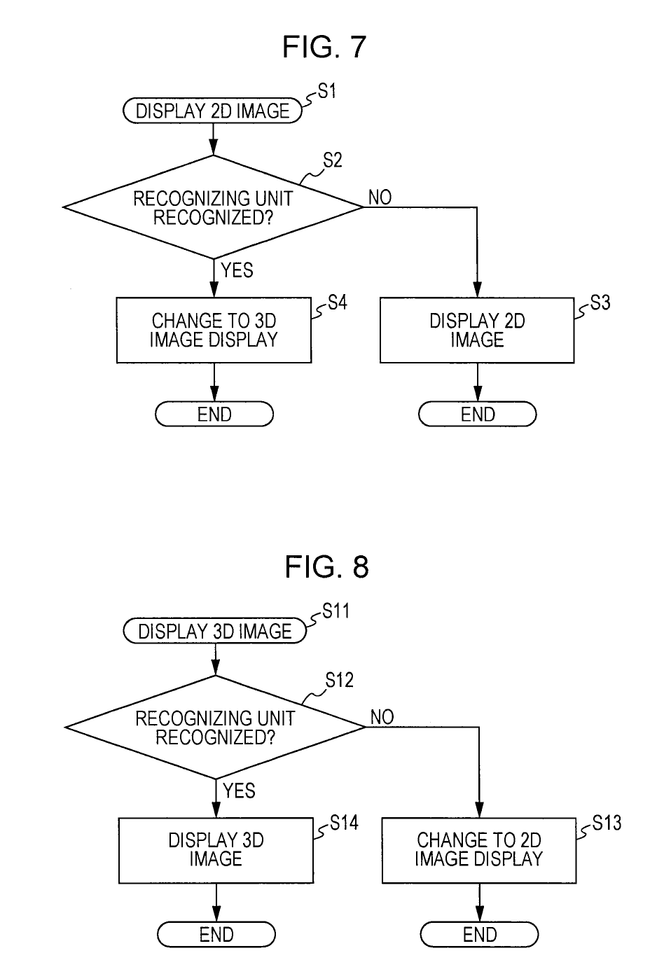

FIG. 7 is a flowchart showing an example of a process of changing a picture when a 2D picture is displayed on the display unit of the image display device according to the example and FIG. 8 is a flowchart showing an example of a process of changing a picture when a 3D picture is displayed on the display unit of the image display device according to an embodiment of the example.

It is difficult to dispose an electric configuration because the autostereoscopic panel is made of plastic or the like. It is difficult to automatically determine attachment/detachment of an autostereoscopic panel in the autostereoscopic panel. Therefore, it is considered to display a guide for attachment/detachment of an autostereoscopic panel in the display unit of the image display device.

When an autostereoscopic panel is mounted on the display unit, a mounting guide of a 2D picture is displayed on the display unit. When the user mounts an autostereoscopic panel on the display unit in accordance with the mounting guide, the mounting guide displayed on the display unit in the 2D picture is covered by the autostereoscopic panel. Therefore, the user has difficulty in seeing the mounting guide displayed in the 2D picture and it is difficult to read the mounting guide.

Further, when the autostereoscopic panel is separated from the display unit, a guide for separating a 3D picture is displayed on the display unit because the autostereoscopic panel is mounted on the display unit. The user separates the autostereoscopic panel from the display unit in accordance with the separating guide. However, the user may not see the 3D picture displayed on the display unit, if not through the autostereoscopic panel. Therefore, the user has difficulty in seeing the separating guide displayed in the 3D picture, such that it is difficult to read the separating guide.

In order to remove the problems, in the image display device 100 of the present disclosure, as described below, the picture displayed on the display unit 2 is automatically changed into a 2D picture or a 3D picture, corresponding to attachment/detachment of the autostereoscopic panel 30.

First, an example of process with a 2D picture displayed on the display unit 2 is described with reference to FIG. 7.

As shown in FIG. 7, when the user starts the image display device 100, a 2D picture is displayed on the display unit 2 of the image display device 100 (step S1). Whether the recognizer 32 can be recognized is determined from Images P1 and P2 (see FIGS. 5 and 6) for determining attachment/detachment of the autostereoscopic panel 30 (step S2). For example, whether the color changes is determined.

The color of the image does not change in the image P1 before the autostereoscopic panel 30 is mounted, which is shown in FIG. 5. When the color of the image captured by the imaging unit 24 changes, the determining unit 6 determines that the autostereoscopic panel 30 is not mounted on the display unit 2 (NO in step S2).

When it is determined that the autostereoscopic panel 30 is not mounted on the display unit 2 (NO in step S2), the display control unit 9 outputs an instruction for keep displaying the 2D picture on the display unit 2. As a result, the image display device 100 is held with the 2D picture displayed on the display unit 2 (step S3).

In the image P2 after the autostereoscopic panel 30 is mounted, which is shown in FIG. 6, the recognizer 32 is projected and a color is applied throughout the image P2. As described above, when a color is applied to the image, the determining unit 6 recognizes the recognizer 32 and determines that the autostereoscopic panel 30 is mounted on the display unit 2 (YES in step S2).

When it is determined that the autostereoscopic panel 30 is mounted on the display unit 2 (YES in step S2), the display control unit 9 outputs an instruction for changing the 2D picture for a 3D picture to display a 3D picture on the display unit 2. Accordingly, a 3D picture is displayed on the display unit 2 (step S4).

Next, an example of process with a 3D picture displayed on the display unit 2 is described with reference to FIG. 8.

As shown in FIG. 8, the 3D picture is displayed on the display unit 2, with the autostereoscopic panel 30 mounted on the display unit 2 (step S11). The imaging unit 24 captures an image that is used for determining attachment/detachment of the autostereoscopic panel 30. Thereafter, the determining unit 6 determines whether the recognizer 32 can be recognized (for example, whether there is a change in color) from the acquired image (step S12).

With the 3D picture displayed on the display unit 2, when the user separates the autostereoscopic panel 30, it is possible to acquire an image with different color from the image P1 shown in FIG. 5 by the imaging unit 24. Accordingly, the determining unit 6 determines that the autostereoscopic panel 30 is not mounted (NO in step 12).

When it is determined that the autostereoscopic panel 30 is not mounted (NO in step S2), the display control unit 9 outputs an instruction for changing the 3D picture for the 2D picture to display the 2D picture on the display unit 2. As a result, the 2D picture is displayed on the display unit 2 (step S13).

On the other hand, with the 3D picture displayed on the display unit 2, until the user separates the autostereoscopic panel 30, it is possible to acquire an image with the same color as the image P2 shown in FIG. 6. The determining unit 6 recognizes the recognizer 33 and determines that the autostereoscopic panel 30 is mounted on the display unit 2 (YES in step S12). Therefore, the image display device 100 is held with the 3D picture displayed on the display unit 2 (step S14).

In this example of process, although the entire recognizer 32 that is imaged by the imaging unit 24 is colored, there may be an error in the determined of the determining unit 6 due to the imaging environment, such as, brightness or darkness of the imaging place. Therefore, the half of the recognizer 32 may be colored or the corners may be colored. Accordingly, it is possible to reduce an error in recognition of the determining unit 6 due to the imaging environment.

Further, when an autostereoscopic panel that is not suitable for the image display device 100 is mounted, a 2D picture is displayed on the display unit 2, similar to when the autostereoscopic panel 30 is not mounted.

Further, changing the 2D picture for the 3D picture may be performed only in a display region of an application corresponding to the 3D picture. Further, when the entire display unit corresponds to the 3D picture, change of a 2D picture and a 3D picture may be performed in the entire display unit.

Further, since the picture displayed on the display unit 2 is automatically selected into a 2D picture or a 3D picture, corresponding to attachment/detachment of the autostereoscopic panel 30, a picture for the user's state can be displayed. As a result, it is not necessary to mount and display a user interface, such as the mounting guide of an autostereoscopic panel, on the display unit of the image display device.

### [Automatic Adjustment of Display Position in 3D Picture]

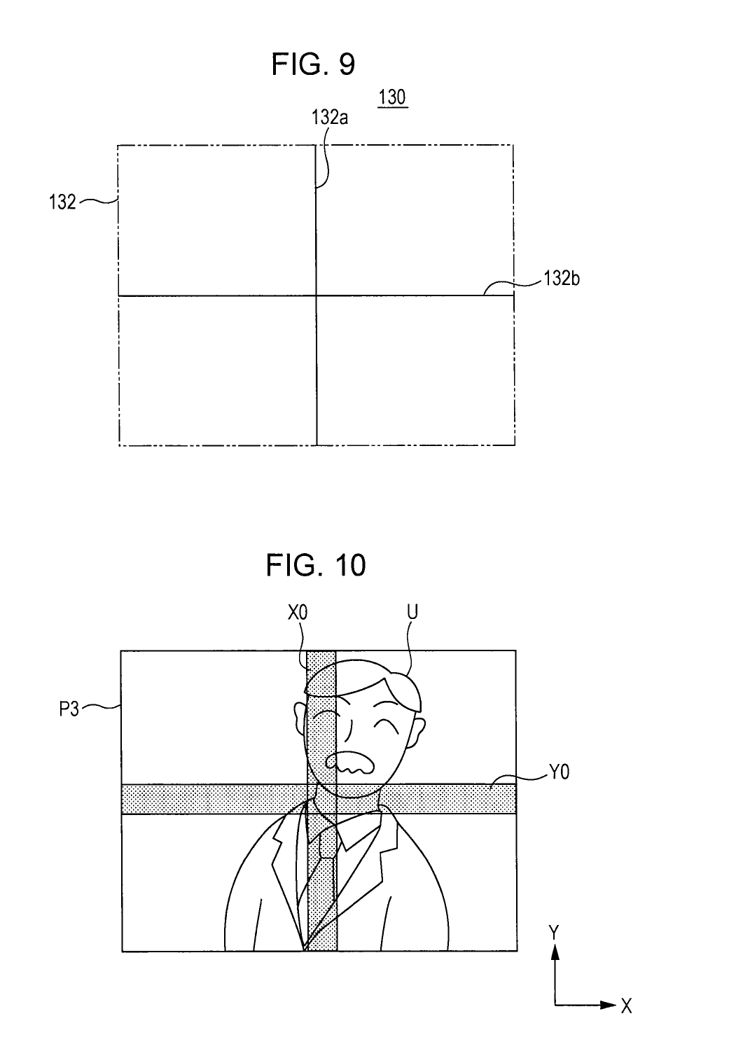

Next, automatic adjustment of a picture displayed on the display unit 2 is described with reference to FIGS. 9 to 12.

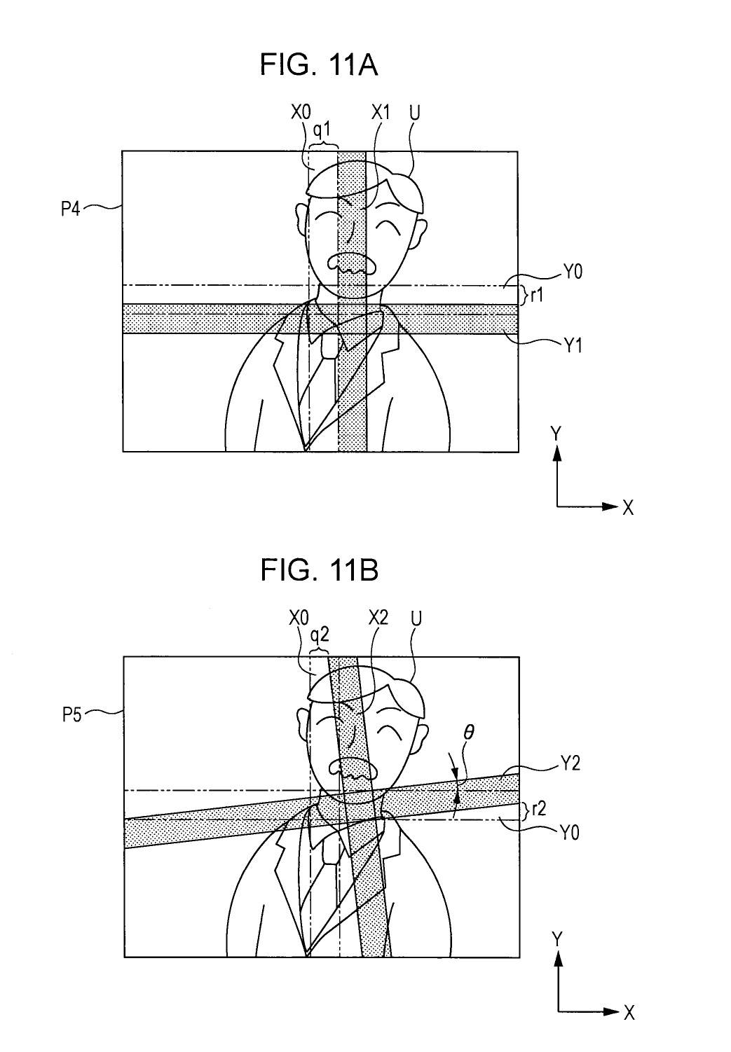

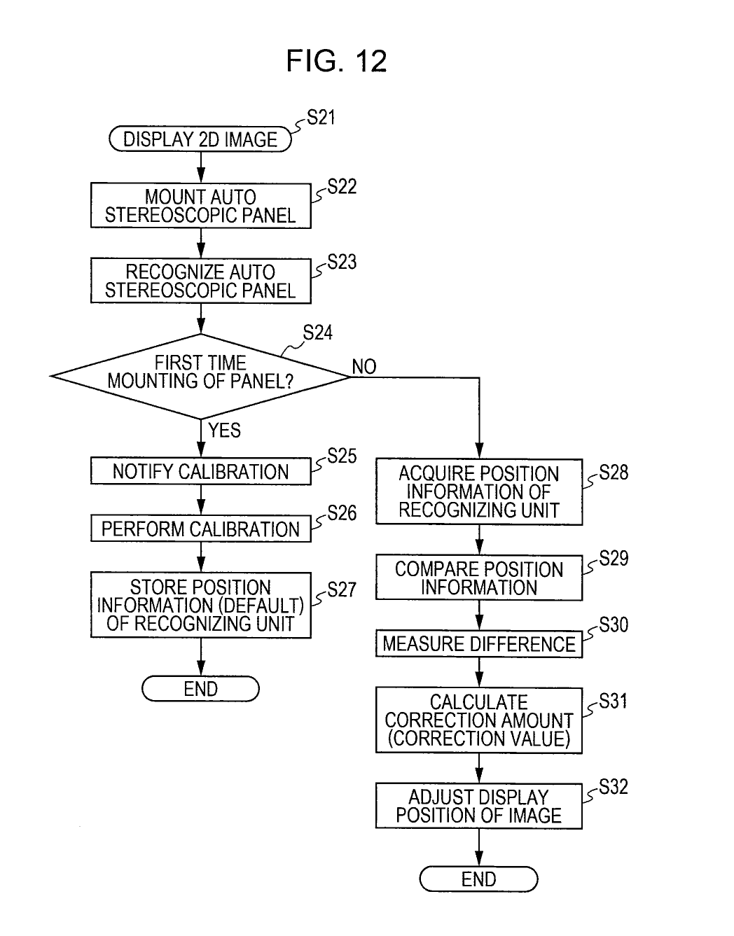

FIG. 9 is a view showing a recognizer in an autostereoscopic panel according to another embodiment and FIG. 10 is a view showing an image captured by an imaging unit when an autostereoscopic panel according to another embodiment has been initially mounted. Further, FIGS. 11A and 11B are views showing an example of an image captured by an imaging unit when an autostereoscopic panel according to another embodiment has been mounted the second and subsequent times and FIG. 12 is a flowchart showing an example of a process of adjusting a display position of a picture displayed on the display unit of the image display device according to the example.

It may be possible to manually perform positioning on the basis of alignment lines formed in a lenticular lens sheet. In this state, the mounting position of the autostereoscopic panel changes every time, such that the accuracy of positioning is decreased. Further, the position relationship between the autostereoscopic panel and the display panel of the display unit is necessary to be adjusted within several μm to tens of μm. As a result, as the accuracy of positioning decreases, the left and right viewpoints are inversed and so-called an inverse viewpoint state with the depth feel inversed is likely to be generated.

In order to remove the problem, in the image display device 100 of the present disclosure, as described above, the display position of the picture displayed on the display unit 2 is automatically adjusted.

An autostereoscopic panel 130 of another embodiment is different in the recognizer from the autostereoscopic panel 30 of the above embodiment. The same components of the autostereoscopic panel 130 as those of the autostereoscopic panel 30 of the above embodiment are given the same reference numerals and the description is not provided. The autostereoscopic panel 130 includes a transmissive unit 31, a recognizer 132, and fixers 33.

As shown in FIG. 9, the recognizer 132 is formed in a substantially rectangular shape. A line 132a aligned parallel to the transverse direction and a line 132b aligned parallel to the longitudinal direction are provided in the recognizer 132. The two lines 132a and 132b intersect each other at the center of the recognizer 132 in a cross shape. Further, the recognizer 132 of the autostereoscopic panel 130, similar to the recognizer 32, is used to determine attachment/detachment of an autostereoscopic panel or change the picture displayed on the displayed unit 2.

Next, an example of process of adjusting the display position of a picture is described with reference to FIGS. 10 to 12.

As shown in FIG. 12, when the user starts the image display device 100, a 2D picture is displayed on the display unit 2 (step S21). The user mounts the autostereoscopic panel 130 on the display unit 2 of the image display device 100 (step S22). The imaging unit 24 captures an image P3 shown in FIG. 10 by imaging the recognizer 132.

The determining unit 6 determines attachment/detachment of an autostereoscopic panel from the acquired image P3 (step S23). Further, the determination of attachment/detachment in the autostereoscopic panel 130 is the same as that described above and is not described.

Next, when it is determined that the autostereoscopic panel 130 has been mounted, a 3D picture is displayed on the display unit 2. Next, the determining unit 6 determines whether the autostereoscopic panel 130 is mounted first time (step S24). When the autostereoscopic panel 130 is mounted first time (YES in step S24), the position information of the autostereoscopic panel 130 is not stored in the memory unit 7. Therefore, it is necessary for the user to perform calibration with the input unit 4. The calibration means a process of moving the display position of the display unit 2 with respect to the autostereoscopic panel 130 to a predetermined position where a 3D picture can be seen with the naked eyes.

The image display device 100 outputs an instruction for performing calibration to the user (step S25). The user performs calibration in accordance with the instruction of the image display device 100 (step S26).

When the calibration is finished, the position information of the recognizer 132 (position information of the autostereoscopic panel 130) to the display unit 2 is stored in the memory unit 7 (step S27) and the process is finished. In this process, the position information of the recognizer 132 stored in the memory unit 7 is the default value, X0 and Y0. Further, the default value X0 indicates the X-directional position of the line 132a of the recognizer 132, when the longitudinal direction of the image captured by the imaging unit 24 is the X direction. The default value Y0 indicates the Y-directional position of the line 132b of the recognizer 132, when the transverse direction of the image captured by the imaging unit 24 is the Y direction.

When the autostereoscopic panel 130 is mounted the second and subsequent times (NO in step S24), the position information of the recognizer 132 imaged by the imaging unit 24 is likely to be shifted from the default values X0 and Y0. Accordingly, default values X0 and Y0 and the position information of the recognizer 132 acquired from the image of the recognizer 132 captured by the imaging unit 24 the second and subsequent times are compared.

The calculating unit 8 acquires the position information X1 and Y1 of the recognizer 132 from the image P4 shown in FIG. 11A (step S28). Thereafter, the calculating unit 8 measures the shifting amount q1 in the X direction and the shifting amount r1 in the Y direction of the image P4 with respect to the image P3 (step S30) by comparing the acquired position information X1 and Y1 of the recognizer 132 with the default values X0 and Y0 (step S29).

Further, the calculating unit 8 calculates a correction amount (correction value) for correcting the display position of the picture displayed on the display unit 2 from the measured shifting amounts q1 and r1 (step S31). Next, the calculating unit 8 sends the calculated correction amount (correction value) to the display control unit 9. The display control unit 9 adjusts the display position of the picture displayed on the display unit 2 on the basis of the correction amount (correction value) (step S32). The adjustment process of the display position of the picture is finished after the picture with the display position adjusted is displayed on the display unit 2.

As shown in FIG. 11B, the autostereoscopic panel 130 is mounted after being rotated with respect to an appropriate position. In this case, the calculating unit 8 acquires the position information X2 and Y2 of the recognizer 132 from the image P5 of the recognizer 132, similar to the image P4, and the inclination θ, and compares them with the default values X0 and Y0. Thereafter, the calculating unit calculates the shifting amount q2 in the X direction and the shifting amount r2 in the Y direction of the image.

Further, the calculating unit 8 calculates a correction amount (correction value) for correcting the display position of the picture displayed on the display unit 2 from the measured shifting amounts q2 and r2 and the inclination θ, and sends the calculated correction amount (correction value) to the display control unit 9. The display control unit 9 adjusts the display position of the picture displayed on the display unit 2 on the basis of the correction amount (correction value) and then displays the picture on the display unit 2.

In the present disclosure, since the display control unit 9 automatically adjusts the display position of the 3D picture displayed on the display unit 2, it is possible to reduce the trouble that the user manually performs positioning. Further, even though the mounting position of the autostereoscopic panel 130 is changed every time, the correction amount is calculated by being compared with the first time (default values), such that it is possible to adjust the display position of the picture displayed on the display unit 2 with high accuracy. Therefore, the 3D image displayed for the user is not inversed, such that the user can see a favorable 3D picture.

Further, it may be possible to perform the calibration, which was performed at the first time, in manufacturing the image display device. Accordingly, the first calibration of the user is not necessary and the user's operation becomes simpler and easier.

### <5. Example of Another Configuration of Recognizer in Autostereoscopic Panel>

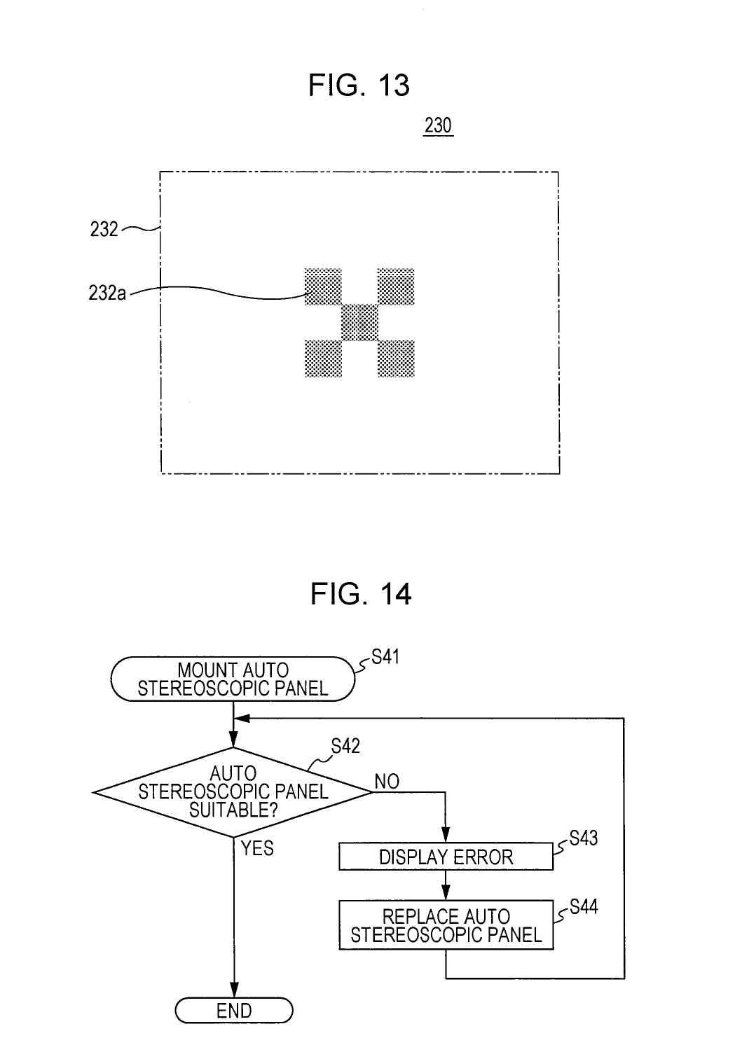

Another example of the recognizer of the autostereoscopic panel is described with reference to FIG. 13.

FIG. 13 is a view showing a recognizer in an autostereoscopic panel 230 according to another embodiment of the present disclosure.

An autostereoscopic panel 230 of another embodiment is different in the recognizer from the autostereoscopic panel 30 of the above embodiment. In description of the matters relating to the recognizer, the same components as those in the autostereoscopic panel 30 according to the above embodiment are not described below.

The autostereoscopic panel 230 includes a transmissive unit 31, a recognizer 232, and fixers 33. As shown in FIG. 13, for example, the recognizer 232 is provided with a 2D barcode mark 232a. The 2D barcode mark 232a, for example, has the information on the resolution, size (including thickness), and version of the autostereoscopic panel 230.

Next, determining whether the autostereoscopic panel 230 is suitable for the image display device 100 by using the information of the recognizer 232 is described with reference to FIG. 14.

FIG. 14 is a flowchart showing an example of a process of determining whether an autostereoscopic panel mounted on the image display device according to the example is suitable for the display unit.

In the example of a process, for example, when an autostereoscopic panel having high resolution is mounted on a display unit having high resolution, an appropriate picture is displayed on the display unit 2, such that the determining unit 6 determines that the autostereoscopic panel is suitable for the display unit. Further, when an autostereoscopic panel having low resolution is mounted on a display unit having high resolution, an appropriate picture is not displayed on the display unit 2, such that the determining unit 6 determines that the autostereoscopic panel is not suitable for the display unit.

As shown in FIG. 14, when the autostereoscopic panel 230 is mounted on the display unit 2 (step S41), the imaging unit 24 images the recognizer 232 of the autostereoscopic panel 230. Further, in addition to determining attachment/detachment of the autostereoscopic panel 230, the determining unit 6 determines whether the autostereoscopic panel 230 is suitable for the image display device 100 (step S42).

In this case, the determining unit 6 first acquires the information of the 2D barcode mark 232a of the recognizer 232. Further, the determining unit 6 determines whether the autostereoscopic panel 30 mounted on the display unit 2 is suitable for the image display device 100 by comparing the information acquired from the 2D barcode mark 232a with the information on an autostereoscopic panel that is suitable for the image display device 100.

When the autostereoscopic panel 230 is not suitable for the image display device 100 (NO in step S42), the fact that the autostereoscopic panel 230 mounted in the image display device 100 is not suitable is displayed on the display panel 21 of the display unit 2, such that the user knows the fact (step S43).

When the user replaces the autostereoscopic panel with the autostereoscopic panel 230 that is suitable for the image display device 100 (step S44), as described above, the recognizer 232 is imaged again. Further, in addition to determining attachment/detachment of the autostereoscopic panel 230, the determining unit 6 determines whether the autostereoscopic panel 230 is suitable for the image display device 100 from the image of the imaged recognizer 232 (step S42).

The determining unit 6 determines whether the autostereoscopic panel 230 is suitable for the image display device 100 until the autostereoscopic panel 230 is suitable for the image display device 100.

When the autostereoscopic panel 230 is suitable for the image display device 100 (YES in step S42), the determining of whether the autostereoscopic panel 230 is suitable for the image display device 100 is finished. Thereafter, calibration or adjustment of the picture displayed on the display unit 2 is performed and the picture is changed from a 2D picture into 3D picture (see FIGS. 7 and 12).

The information on the recognizer 232 of the autostereoscopic panel 230 is not limited to the resolution, size, and version. For example, the information may include optical information, such as the thickness, the lens pitch, the inclination, and the lens shape of the autostereoscopic panel, or the information on the type of the device. Therefore, the maintenance by software is not necessary.

The other configurations are the same as those of the autostereoscopic panel 30 according to the above embodiment, such that they are not described. Even in the autostereoscopic panel 230 having the configuration, it is possible to achieve the same operation and effect as those of the autostereoscopic panel 30 according to the above embodiment.

The present disclosure has the following configuration.

(1) An information processing apparatus, comprising: a processor that determines whether an autostereoscopic panel is attached to a display, and controls the display to display a 2D image or 3D image based on the determination.

(2) The information processing apparatus of (1), wherein the processor controls the display to display a 3D image when it is determined that the autostereoscopic panel is attached to the display.

(3) The information processing apparatus of (1) or (2), wherein the processor controls the display to display a 2D image when it is determined that the autostereoscopic panel is not attached to the display.

(4) The information processing apparatus of any one of (1) to (3), wherein the processor determines whether an autostereoscopic panel is attached to the display by detecting a change in a characteristic of an image displayed by the display.

(5) The information processing apparatus of (4), wherein the processor controls the display to display a 2D image and detects whether a characteristic of the displayed 2D image is changed.

(6) The information processing apparatus of (5), wherein, when the processor detects that a characteristic of the 2D image is changed, the processor determines that the autostereoscopic panel is attached to the display and controls the display to display a 3D image.

(7) The information processing apparatus of (4) or (5), wherein when the processor detects that a characteristic of the 2D image is not changed, the processor determines that the autostereoscopic panel is not attached to the display and controls the display to continue displaying a 3D image.

(8) The information processing apparatus of (4), wherein the processor controls the display to display a 3D image and detects whether a characteristic of the displayed 3D image is changed.

(9) The information processing apparatus of (8), wherein, when the processor detects that a characteristic of the 3D image is changed, the processor determines that the autostereoscopic panel is attached to the display and controls the display to continue displaying the 3D image.

(10) The information processing apparatus of (8) or (9), wherein when the processor detects that a characteristic of the 3D image is not changed, the processor determines that the autostereoscopic panel is not attached to the display and controls the display to display a 2D image.

(11) The information processing apparatus of (4), wherein the detected change in a characteristic corresponds to a change in color of the image displayed by the display.

(12) The information processing apparatus of (4) or (12), wherein the detected change in a characteristic corresponds to a change in shape of the image displayed by the display.

(13) The information processing apparatus of any one of (1) to (12), wherein the processor determines a position of the autostereoscopic panel, and controls the display to adjust a position of a displayed image based on the determined position.

(14) The information processing apparatus of any one of (1) to (12), wherein the processor determines whether the autostereoscopic panel is attached to the display for a first time.

(15) The information processing apparatus of (14), wherein, when the processor determines that the autostereoscopic panel is attached to the display for the first time, the processor determines the position of the autostereoscopic panel and stores the position information in memory.

(16) The information processing apparatus of (14) or (15), wherein, when the processor determines that the autostereoscopic panel is attached to the display and that the position information is stored in memory, the processor determines a current position of the autostereoscopic panel and determines a difference between the position information stored in the memory and the current position information and controls the display to adjust a position of a displayed image based on the determined difference.

(17) The information processing apparatus of any one of (1) to (17), wherein the processor obtains information corresponding to the autostereoscopic panel and determines whether the autostereoscopic panel is suitable for the information processing apparatus based on the obtained information.

(18) The information processing apparatus of (17), wherein the information corresponding to the autostereoscopic panel is read from the autostereoscopic panel.

(19) The information processing apparatus of (17) or (18), wherein the information corresponding to the autostereoscopic panel includes at least one of a resolution of the autostereoscopic panel, a size of the autostereoscopic panel, a version of the autostereoscopic panel, a thickness the autostereoscopic panel, a lens pitch the autostereoscopic panel, an inclination the autostereoscopic panel, and a lens shape of the autostereoscopic panel.

(20) A method performed by an information processing apparatus, the method comprising: determining, by a processor of the information processing apparatus, whether an autostereoscopic panel is attached to a display; and controlling, by the processor, the display to display a two-dimensional (2D) image or three-dimensional (3D) image based on the determining.

(21) A non-transitory computer-readable medium including computer program instructions, which when executed by an information processing apparatus, cause the information processing apparatus to perform a method comprising: determining whether an autostereoscopic panel is attached to a display; and controlling the display to display a two-dimensional (2D) image or three-dimensional (3D) image based on the determining.

Further, the present disclosure is not limited to the embodiments shown in the drawings and may be modified in various ways without departing from the spirit of the present disclosure.

In the present disclosure, the imaging unit of the image display device recognizes the recognizer disposed on the autostereoscopic panel, thereby performing the operation described above. Therefore, it is possible to easily apply an autostereoscopic panel to various image display devices.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a processor that determines whether an autostereoscopic panel is attached to a display, and controls the display to display a two-dimensional (2D) image or three-dimensional (3D) image based on the determination.

2. The information processing apparatus of claim 1, wherein the processor controls the display to display a 3D image when it is determined that the autostereoscopic panel is attached to the display.

3. The information processing apparatus of claim 1, wherein the processor controls the display to display a 2D image when it is determined that the autostereoscopic panel is not attached to the display.

4. The information processing apparatus of claim 1, wherein the processor determines whether an autostereoscopic panel is attached to the display by detecting a change in a characteristic of an image displayed by the display.

5. The information processing apparatus of claim 4, wherein the processor controls the display to display a 2D image and detects whether a characteristic of the displayed 2D image is changed.

6. The information processing apparatus of claim 5, wherein, when the processor detects that a characteristic of the 2D image is changed, the processor determines that the autostereoscopic panel is attached to the display and controls the display to display a 3D image.

7. The information processing apparatus of claim 5, wherein when the processor detects that a characteristic of the 2D image is not changed, the processor determines that the autostereoscopic panel is not attached to the display and controls the display to continue displaying a 3D image.

8. The information processing apparatus of claim 4, wherein the processor controls the display to display a 3D image and detects whether a characteristic of the displayed 3D image is changed.

9. The information processing apparatus of claim 8, wherein, when the processor detects that a characteristic of the 3D image is changed, the processor determines that the autostereoscopic panel is attached to the display and controls the display to continue displaying the 3D image.

10. The information processing apparatus of claim 8, wherein when the processor detects that a characteristic of the 3D image is not changed, the processor determines that the autostereoscopic panel is not attached to the display and controls the display to display a 2D image.

11. The information processing apparatus of claim 4, wherein the detected change in a characteristic corresponds to a change in color of the image displayed by the display.

12. The information processing apparatus of claim 4, wherein the detected change in a characteristic corresponds to a change in shape of the image displayed by the display.

13. The information processing apparatus of claim 1, wherein the processor determines a position of the autostereoscopic panel, and controls the display to adjust a position of a displayed image based on the determined position.

14. The information processing apparatus of claim 1, wherein the processor determines whether the autostereoscopic panel is attached to the display for a first time.

15. The information processing apparatus of claim 14, wherein, when the processor determines that the autostereoscopic panel is attached to the display for the first time, the processor determines the position of the autostereoscopic panel and stores the position information in memory.

16. The information processing apparatus of claim 14, wherein, when the processor determines that the autostereoscopic panel is attached to the display and that the position information is stored in memory, the processor determines a current position of the autostereoscopic panel and determines a difference between the position information stored in the memory and the current position information and controls the display to adjust a position of a displayed image based on the determined difference.

17. The information processing apparatus of claim 1, wherein the processor obtains information corresponding to the autostereoscopic panel and determines whether the autostereoscopic panel is suitable for the information processing apparatus based on the obtained information.

18. The information processing apparatus of claim 17, wherein the information corresponding to the autostereoscopic panel is read from the autostereoscopic panel.

19. A method performed by an information processing apparatus, the method comprising:
determining, by a processor of the information processing apparatus, whether an autostereoscopic panel is attached to a display; and
controlling, by the processor, the display to display a two-dimensional (2D) image or three-dimensional (3D) image based on the determining.

20. A non-transitory computer-readable medium including computer program instructions, which when executed by an information processing apparatus, cause the information processing apparatus to perform a method comprising:
determining whether an autostereoscopic panel is attached to a display; and
controlling the display to display a two-dimensional (2D) image or three-dimensional (3D) image based on the determining.
